(19) United States
(12) Patent Application Publication
(10) Pub. No.: US 2002/0138296 A1
(43) Pub. Date: Sep. 26, 2002

(54) Systems and methods for collecting and rating contact center usage

(76) Inventor: Ralph K. Holmes JR., Owings, MD (US)

Correspondence Address: WORLDCOM, INC., TECHNOLOGY LAW DEPARTMENT, 1133 19TH STREET NW, WASHINGTON, DC, 20036, US

(21) Appl. No.: 10/098,044

(22) Filed: Mar. 15, 2002

Related U.S. Application Data
(60) Provisional application No. 60/276,923, filed on Mar. 20, 2001.
(60) Provisional application No. 60/276,953, filed on Mar. 20, 2001.
(60) Provisional application No. 60/276,954, filed on Mar. 20, 2001.
(60) Provisional application No. 60/276,955, filed on Mar. 20, 2001.

(51) Int. Cl. G06F 17/60

(52) U.S. Cl. 705/1

(57) ABSTRACT

A method for billing customers for services associated with routing communications from a contact center includes charging the customer on a per-agent basis. At the end of a billing cycle, a data collection/billing unit determines the number of agents that received at least a predetermined number of communications from the contact center or the number of agents that logged into the contact center. The customer is then charged a fixed amount for each of these agents. The data collection/billing unit may also identify agents that received at least the predetermined number of communications or who logged into the contact center, but were not active during the entire billing cycle. The fixed amount for these agents may then be prorated based on the portion of the billing cycle that they were active.

### RELATED APPLICATION

This application claims priority under 35 U.S.C. § 119(e) based on the following U.S. Provisional Applications: Serial Nos. 60/276,923, 60/276,953, 60/276,954, and 60/276,955, all filed Mar. 20, 2001, the disclosures of which are incorporated herein by reference.

### FIELD OF THE INVENTION

The present invention relates generally to contact centers supported by telecommunications service providers and, more particularly, to systems and methods for billing for services associated with a contact center.

### BACKGROUND OF THE INVENTION

Many businesses now provide call centers or contact centers to field phone calls, e-mails, etc. from their customers. For example, a business that sells products or provides services may have a 1-800 number that customers can call to ask questions, get product information, etc. The business typically employs a number of agents and supervisors that work in the contact center to field the phone calls, e-mails, etc. and assist the customers.

In today's contact center environment, a number of the agents and supervisors may work at different locations. For example, one agent may be located in Virginia while another agent may be located in Texas. When calls are received, the calls are routed to an available agent over a telecommunications network. For example, when a 1-800 call is received, a telecommunications service provider may route the call to a contact center platform. The contact center platform may identify the customer associated with the 1-800 number and an available agent for that customer. The telecommunications service provider may then route the call to the agent over the service provider's network.

In a typical call center environment, the telecommunications service provider tracks each event that it performs on behalf of the customer. For example, the telecommunications service provider tracks the number of phone calls routed, the number of faxes sent, the number of e-mails routed, etc. The telecommunications service provider then bills the customer based on the events that it performed. As the number of calls, e-mails, etc., that are received and routed increases, keeping track of all the events becomes complex and costly. Another problem with tracking events in this manner is that the customer is often unable to verify all the events performed on its behalf and is ultimately unable to determine whether the bill accurately reflects the services provided.

### SUMMARY OF THE INVENTION

There exists a need for systems and methods for billing customers for services associated with a contact center while reducing the tracking and record keeping associated with conventional event driven billing models.

These and other needs are met by the present invention where contact center usage is billed on a per-agent basis. When an agent performs transactions on behalf of a customer, the agent's company is charged a flat rate regardless of the number of events performed. In this manner, the customer is provided with a simpler billing model and is able to easily verify the accuracy of the bill.

According to one aspect of the invention, a method for billing a customer for services associated with a contact center is provided. The method includes determining a number of agents associated with the customer during a billing cycle. The method also includes charging the customer a fixed amount for each agent.

Another aspect of the present invention provides a computer-readable medium having stored instructions which when executed by a processor, cause the processor to monitor a contact center server for agent activity information, where the server stores information for a group of agents associated with a customer. The instructions also cause the processor to determine a first number of agents that received at least one communication or logged into the contact center server during a billing cycle and charge the customer a fixed amount for each of the first number of agents.

A further aspect of the present invention provides a support system that includes a contact center server, a data collection unit and a billing unit. The contact center server is configured to store agent information for a number of customers. The data collection unit is configured to monitor the contact center server, determine a first number of agents that logged into the contact center server or received at least one communication from the contact center server during a billing cycle and forward this first number of agents. The billing unit is configured to receive the first number of agents and charge the customer a fixed amount for each of the first number of agents.

In still another aspect of the present invention, a contact center platform is provided. The contact center platform includes a database configured to store information on a group of agents associated with a customer. The contact center platform also includes a server configured to receive communications intended for the customer, access the database to identify an agent associated with the customer and forward the communication to the identified agent. The server is also configured to determine a first number of agents that received at least a predetermined number of communications during a billing cycle and generate billing information based on a fixed amount for each of the first number of agents.

Other features and advantages of the present invention will become readily apparent to those skilled in this art from the following detailed description. The embodiments shown and described provide illustration of the best mode contemplated for carrying out the invention. The invention is capable of modifications in various obvious respects, all without departing from the invention. Accordingly, the drawings are to be regarded as illustrative in nature, and not as restrictive.

### BRIEF DESCRIPTION OF THE DRAWINGS

Reference is made to the attached drawings, wherein elements having the same reference number designation may represent like elements throughout.

FIG. 1 is a block diagram of an exemplary system in which methods and systems consistent with the present invention may be implemented.

FIG. 2 illustrates an exemplary configuration of a user device of FIG. 1 in an implementation consistent with the present invention.

FIG. 3 illustrates an exemplary configuration of the operational support system (OSS) of FIG. 1 in an implementation consistent with the present invention.

FIG. 4 illustrates an exemplary configuration of the process management system of FIG. 3 in an implementation consistent with the present invention.

FIG. 5 illustrates an exemplary functional block diagram of the process management system of FIG. 3 in an implementation consistent with the present invention.

FIG. 6 illustrates an exemplary configuration of the voice portal of FIG. 3 in an implementation consistent with the present invention.

FIG. 7 illustrates an exemplary configuration of the web center of FIG. 3 in an implementation consistent with the present invention.

FIG. 8 illustrates an exemplary configuration of the Internet Protocol communications (IPCOM) unit of FIG. 3 in an implementation consistent with the present invention.

FIG. 9 illustrates an exemplary configuration of the very high performance backbone network service (vBNS+) unit of FIG. 3 in an implementation consistent with the present invention.

FIG. 10 illustrates an exemplary configuration of the agent information database of FIG. 7 in an implementation consistent with the present invention.

FIGS. 11-12 are flow diagrams illustrating exemplary processing by the OSS in an implementation consistent with the present invention.

### DETAILED DESCRIPTION

The following detailed description of implementations consistent with the present invention refers to the accompanying drawings. The same reference numbers in different drawings may identify the same or similar elements. Also, the following detailed description does not limit the invention. Instead, the scope of the invention is defined by the appended claims and equivalents.

Systems and methods consistent with the present invention provide a billing model that charges a customer for contact center services on a per-agent basis. The customer may be charged a fixed rate for each agent regardless of the number of communications routed to or from each agent.

### Exemplary System

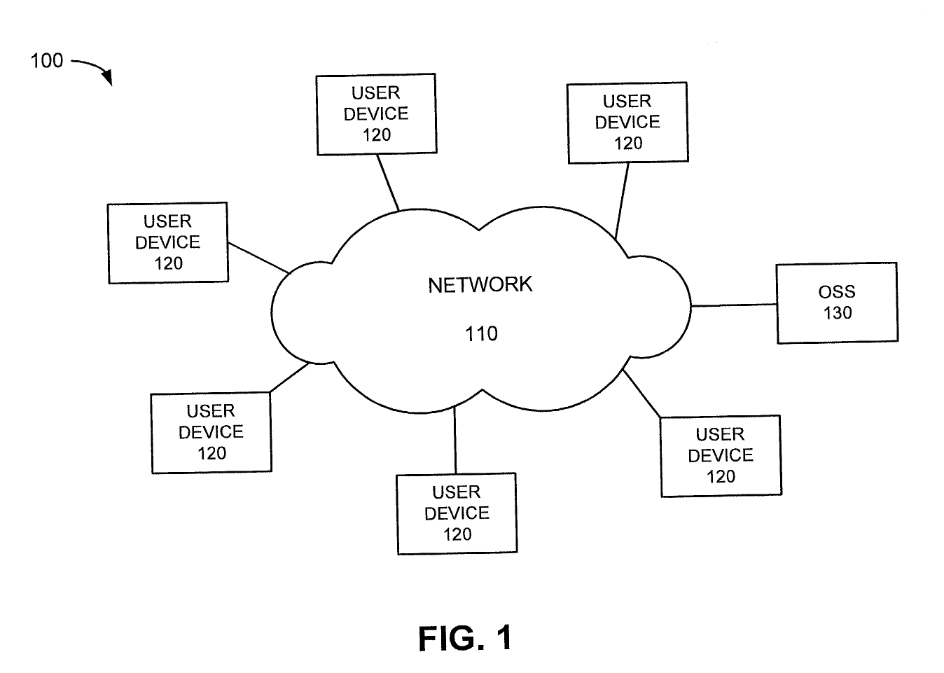

FIG. 1 illustrates an exemplary system 100 in which methods and systems consistent with the present invention may be implemented. In FIG. 1, system 100 includes a network 110 that interconnects a group of user devices 120 and an operational support system (OSS) 130. It will be appreciated that a typical system may include more or fewer devices than illustrated in FIG. 1. Moreover, system 100 may include additional devices (not shown) that aid in the transfer, processing, and/or reception of data.

The network 110 may include, for example, the Internet, an intranet, a local area network (LAN), a metropolitan area network (MAN), a wide area network (WAN), a public switched telephone network (PSTN), and/or some other similar type of network. In fact, the network 110 may include any type of network or combination of networks that permits routing of information from a particular source to a particular destination.

The user devices 120 may include a type of computer system, such as a mainframe, minicomputer, or personal computer, a type of telephone system, such as a POTS telephone or a session initiation protocol (SIP) telephone, and/or some other similar type of device that is capable of transmitting and receiving information to/from the network 110. The user device 120 may connect to the network via any conventional technique, such as a wired, wireless, or optical connection.

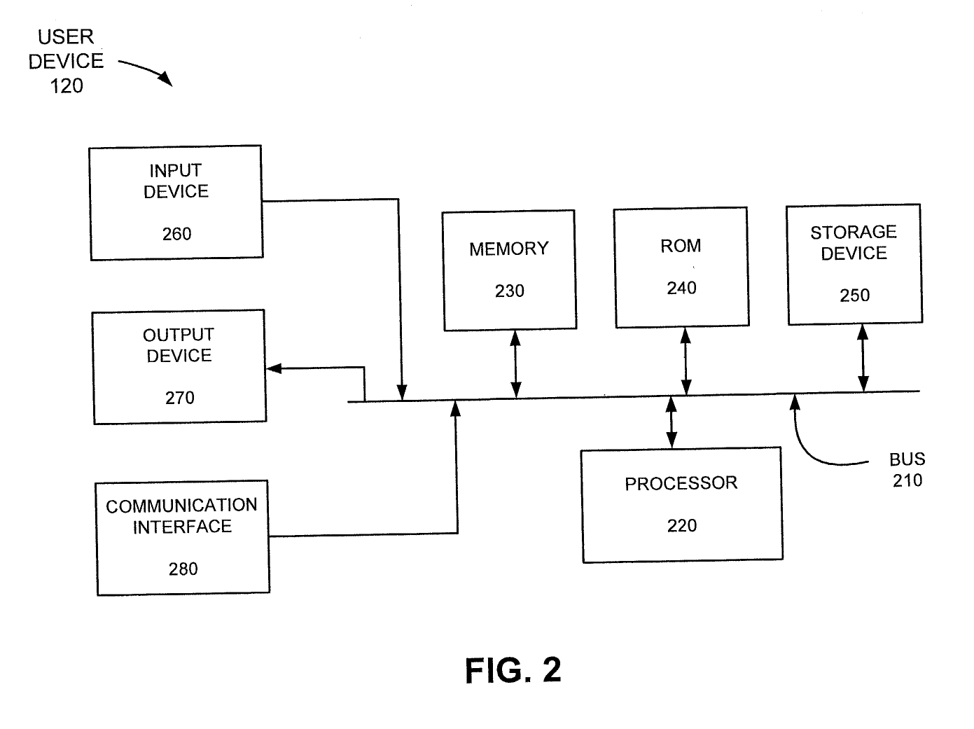

FIG. 2 illustrates an exemplary configuration of a user device 120 of FIG. 1 in an implementation consistent with the present invention. In FIG. 2, the user device 120 includes a bus 210, a processor 220, a memory 230, a read only memory (ROM) 240, a storage device 250, an input device 260, an output device 270, and a communication interface 280. The bus 210 may include one or more conventional buses that permit communication among the components of the user device 120.

The processor 220 may include any type of conventional processor or microprocessor that interprets and executes instructions. The memory 230 may include a random access memory (RAM) or another type of dynamic storage device that stores information and instructions for execution by the processor 220. The memory 230 may also be used to store temporary variables or other intermediate information during execution of instructions by processor 220.

The ROM 240 may include a conventional ROM device and/or another type of static storage device that stores static information and instructions for the processor 220. The storage device 250 may include a magnetic disk or optical disk and its corresponding drive and/or some other type of magnetic or optical recording medium and its corresponding drive for storing information and/or instructions.

The input device 260 may include any conventional mechanism that permits an operator to input information to the user device 120, such as a keyboard, a mouse, a microphone, a pen, a biometric input device, such as voice recognition device, etc. The output device 270 may include any conventional mechanism that outputs information to the operator, including a display, a printer, a speaker, etc.

The communication interface 280 may include any transceiver-like mechanism that enables the user device 120 to communicate with other devices and/or systems, such as OSS 130. For example, the communication interface 280 may include a modem or an Ethernet interface to a network. Alternatively, communication interface 280 may include other mechanisms for communicating via a data network.

Returning to FIG. 1, the OSS 130 provides the infrastructure for integrating applications supporting traditional telephony services and applications supporting non-traditional products/services. Through OSS 130, customers, using, for example, user device 120, may manage, configure, and provision services in real time, obtain real-time billing information, and generate reports using a rules-centric middleware core. In one embodiment, a customer may perform these functions through a single point of entry using an Internet accessible web interface.

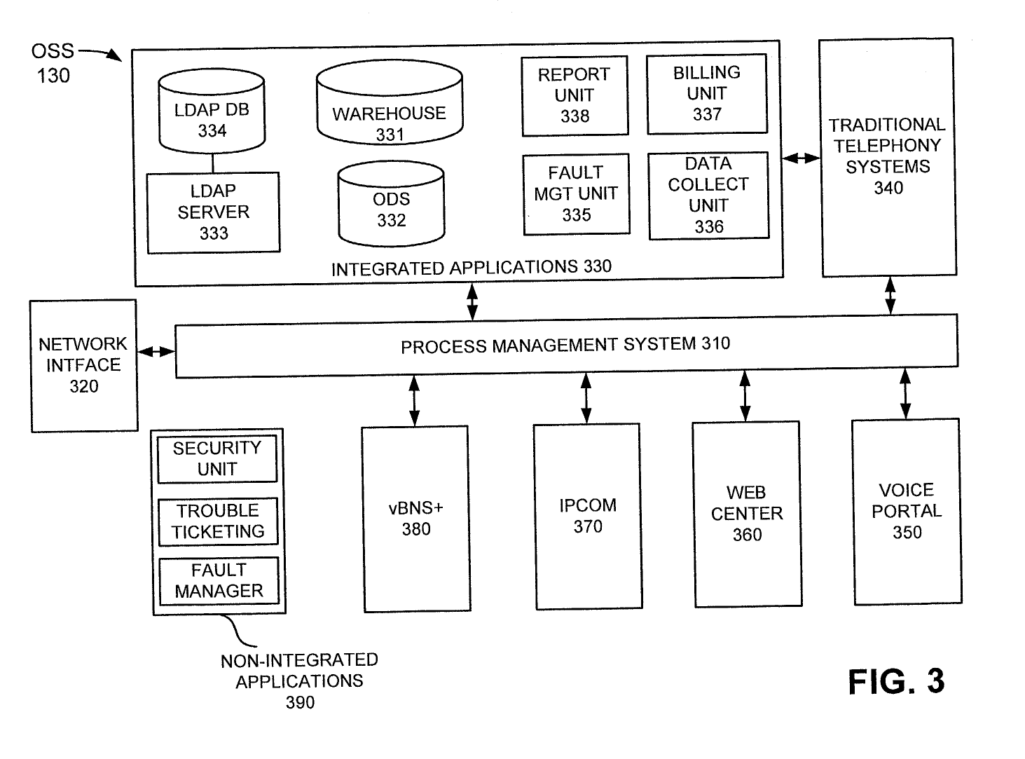

FIG. 3 illustrates an exemplary configuration of the OSS 130 of FIG. 1 in an implementation consistent with the present invention. As illustrated, the OSS 130 includes a process management system 310, a network interface 320, a group of integrated applications 330, a group of traditional telephony systems 340, a voice portal unit 350, a web center unit 360, an Internet Protocol communications (IPCOM) unit 370, a very high performance backbone network service (vBNS+) unit 380, and a group of non-integrated applications 390. It will be appreciated that the OSS 130 may include other components (not shown) that aid in receiving, processing, and/or transmitting data.

The process management system 310 acts as the backbone to the OSS 130 by providing graphical process automation, data transformation, event management, and flexible connectors for interfacing with OSS 130 components. In one implementation consistent with the present invention, the process management system 310 uses a Common Object Request Broker Architecture (CORBA) based publish-and-subscribe messaging middleware to integrate the different components of the OSS 130. The process management system 310 may, for example, be implemented using Vitria Technology Inc.'s BusinessWare software system. Other techniques for integrating the different components of the OSS 130 may also be used, such as extensible markup language (XML) or Enterprise JavaBeans (EJB).

The network interface 320, also referred to as the web front end, provides a graphical user interface that allows users (e.g., customers, engineers, account teams, and the like) to access the components of the OSS 130. The network interface 320 may include commercial off the shelf (COTS) software or hardware packages, such as Siteminder by Netegrity Inc. and/or iPlanet by Sun Microsystems Inc., custom software or hardware or a combination of custom software/hardware and COTS software/hardware.

The network interface 320 may, for example, allow customers to request a new service or terminate an existing service and monitor or change network or user settings/preferences. The network interface 320 may also allow customers to obtain reports and billing information, perform account management and perform trouble reporting and tracking, all in a real time manner. The network interface 320 may also allow engineers to submit transactions to control and configure network elements and services in a real time manner. The network interface 320 may also allow account teams to create and cancel accounts, generate sub-accounts from master accounts, access current account data, and access historical account data.

The network interface 320 authenticates users and controls actions that authenticated users are allowed to execute in the OSS 130. In one implementation consistent with the present invention, the network interface 320 allows users access to the components of the OSS 130 via a single sign-on technique. This single sign-on eliminates the need for users to sign in (or authenticate themselves) in order to access different components of the OSS 130.

The integrated applications 330 may include, for example, a data warehouse 331, an operational data store (ODS) 332, a lightweight directory access protocol (LDAP) based server 333, an LDAP database 334, a fault management unit 335, a data collection unit 336, a billing unit 337 and a reporting unit 338. The data warehouse 331 may include one or more separate databases for storing data. The data warehouse 331 acts as a repository for service order, account, usage and performance data. In one implementation, the data warehouse 331 may be implemented as a relational database management system (RDBMS) and may include a server (not shown) that controls access to the data warehouse 331.

The ODS 332 may also include one or more separate databases for storing data. The ODS 332 temporarily stores data that is used in the course of fulfilling, for example, account creation, service order management, and network provisioning operations. The ODS 332 also stores authentication and authorization data. This data defines user's roles and privileges. Like the data warehouse 331, the ODS 332 may be a RDBMS and may include a server (not shown) that controls access to the ODS 332.

The LDAP server 333 may be a general directory server that controls access to the LDAP database 334. The LDAP database 334 may be an LDAP-based repository that stores information associated with users in a hierarchical, tree-like structure. For example, the LDAP database 334 may store attributes for a user that may include preferences associated with the following exemplary services: call blocking, follow-me, call forwarding, voice mail, conference calling, single line extension, call screening, quality of service, class of service, dial plan restrictions, dynamic registration, secondary directory number and call transfer. The LDAP database 334 may store this information as one or more directory entries for each user. Each directory entry may include an identifier associated with the user and a collection of attributes associated with the user. Each of the attributes may include a type and one or more values that identify the user's settings associated with that type. In this manner, the LDAP server 333 and LDAB database 334 provide a system that enables the user's preferences regarding various services to be stored, searched, updated and retrieved in an efficient manner. The LDAP server 333 and LDAP database 334 are shown as separate devices. It should be understood, however, that these two devices may both be part of the same directory server in implementations consistent with the present invention.

The fault management unit 335 monitors and manages the operation of the OSS 130. The fault management unit 335 may receive information from every device, computer and application in the OSS 130 via the process management system 310. In situations where a fault has been detected, the fault management unit 335 may transmit a trouble ticket identifying the fault to the appropriate system administrator.

The data collection unit 336 collects usage and performance data for the products supported by the OSS 130. In one implementation, the data collection unit 336 utilizes a hierarchical architecture, having a centralized manager that defines and manages collection and data transformation. Individual, lower level gatherers interface with source targets. The data collection unit 336 may aggregate the gathered data and provide the data to other end-user applications in a desired format. For example, data collection unit 336 may provide various records to billing unit 337.

The billing unit 337 receives customer usage and performance data from the data collection unit 336 and generates charge information based on the collected data. The billing unit 337 may be configured with a variety of rating rules and plans and may provide mechanisms to manage and create rating plans. The rating rules may include traditional telephony styled rating rules that include time-of-day, day-of-week, distance-based, flat rate, non-recurring and recurring on a definably regular basis, such as weekly, bi-weekly, monthly, etc. In an exemplary implementation of the present invention, the billing unit 337 may provide bonus points, airline miles and other incentives as part of the rules-based rating and billing service.

The billing unit 337 may provide revenue and billing reports to authorized parties. The billing unit 337 may further allow customers to access previous invoices and view current charges not yet billed. In an exemplary implementation consistent with the present invention, the billing unit 337 may transfer rated events and summary records into other billing and revenue systems. For example, billing unit 337 may receive and transfer billing information or event information to a legacy billing system (i.e., an existing billing system) that generates the actual bill. In alternative implementations, billing unit 337 may provide hard copy bills and/or provide electronic bills to a customer. In this implementation, billing unit 337 may also be configured to perform electronic payment handling.

As customer orders and accounts are created or modified through normal business functions, the OSS 130 keeps the billing unit 337 up to date in a real-time manner. Authorized parties may also extract real-time data from the billing unit 337.

The reporting unit 338 may interact with various components of the OSS 130, such as the data warehouse 331, the data collection unit 336 and the billing unit 337, to provide user (i.e., customers, engineers and account team members) with the ability to obtain reports based on real-time data. The reports may include, for example, billing reports, reports regarding the usage and/or performance of the network, etc.

The traditional telephony systems 340 may include one or more components that are typically used in a telecommunications network. In one implementation, the traditional telephony systems 340 include one or more legacy systems, such as an order entry system, provisioning system, billing system, and the like.

The voice portal unit 350 provides a variety of information services to subscribers. These services may include, for example, banking, brokerage, and financial services, sports, weather, travel and entertainment services, distribution and shipping services, insurance services, health and pharmaceutical services, manufacturing services, and the like. The voice portal unit 350 may store subscriber profiles to determine a subscriber's device preference (e.g., a cellular telephone, a personal digital assistant, a paging device, a computer, a session initiation protocol (SIP) device, and the like). The voice portal unit 350 may also track a subscriber's access to the services provided for billing purposes.

The web center 360 acts as a virtual call center by queuing, routing and distributing communications from any first location to an appropriate agent at any second location. The web center 360 allows agents to handle multiple mediums, such as inbound telephone calls, faxes, e-mails, instant messages, voicemail, voice over IP (VoIP) transactions, etc., via a single browser-based interface. In one implementation, the web center 360 may be implemented using CallCenter@nywhere from Telephony@Work, Inc. The services associated with routing the calls, faxes, e-mails, instant messages, voicemails, VoIP calls, etc. to and from the agents may be billed to the customer on a per-agent basis, as described in more detail below. Billing the customer on a per-agent basis, as opposed to an event driven billing model, significantly reduces the amount of data collection and greatly reduces the costs associated with generating a bill.

The IPCOM unit 370 may include one or more devices that provide VoIP services to subscribers. The subscribers may make and receive calls via an IP communications network using, for example, session initiation protocol (SIP) telephones. The IPCOM unit 370 may support the following services: follow me, call blocking, call forwarding, voice mail, conference calling, single line extension, call screening, quality of service, class of service, dial-plan restrictions, dynamic registration, secondary directory number, and call transfer. Customers may set or change attributes associated with these features via the network interface 320. In an exemplary implementation of the invention, the IPCOM unit 370 may provide for routing VoIP calls to and from agents associated with web center 360.

The vBNS+ unit 380 provides the IP infrastructure for the IP communications network. The vBNS+ unit 380 may include a group of edge routers for routing packets in the network. The non-integrated applications 390 may include, for example, a security unit, a trouble ticketing unit, and a fault manager. The security unit may include one or more firewalls for securing the network interface 320, telephone equipment (e.g., PBX, switch, redirect server, etc.) and network equipment. The trouble ticketing unit manages the issuance and resolution of trouble tickets and the fault manager monitors the hardware components of the OSS 130.

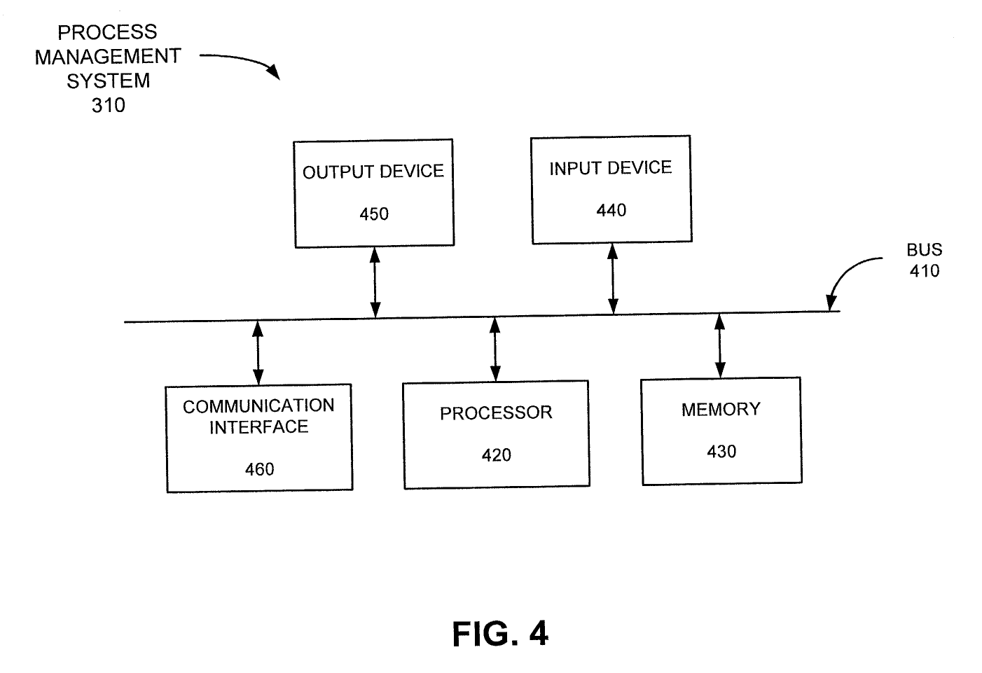

FIG. 4 illustrates an exemplary configuration of the process management system 310 of FIG. 3 in an implementation consistent with the present invention. As illustrated, the process management system 310 includes a bus 410, a processor 420, a memory 430, an input device 440, an output device 450, and a communication interface 460. The bus 410 permits communication among the components of the process management system 310.

The processor 420 may include any type of conventional processor or microprocessor that interprets and executes instructions. The memory 430 may include a RAM or another type of dynamic storage device that stores information and instructions for execution by the processor 420; a ROM or another type of static storage device that stores static information and instructions for use by the processor 420; and/or some type of magnetic or optical recording medium and its corresponding drive.

The input device 440 may include any conventional mechanism that permits an operator to input information to the process management system 310, such as a keyboard, a mouse, a pen, voice recognition and/or biometric mechanisms, and the like. The output device 450 may include any conventional mechanism that outputs information to the operator, including a display, a printer, a speaker, etc. The communication interface 460 may include any transceiver-like mechanism that enables the process management system 310 to communicate with other devices and/or systems, such as the network interface 320, integrated applications 330, traditional telephony systems 340, etc. via a wired, wireless, or optical connection.

As discussed previously, process management system 310 may run a CORBA-based program to integrate various components of the OSS 130. As such, execution of the sequences of instructions associated with the program contained in a computer-readable medium, such as memory 430, causes processor 420 to implement the functional operations described below. In alternative embodiments, hardwired circuitry may be used in place of or in combination with software instructions to implement the present invention. Thus, the present invention is not limited to any specific combination of hardware circuitry and software.

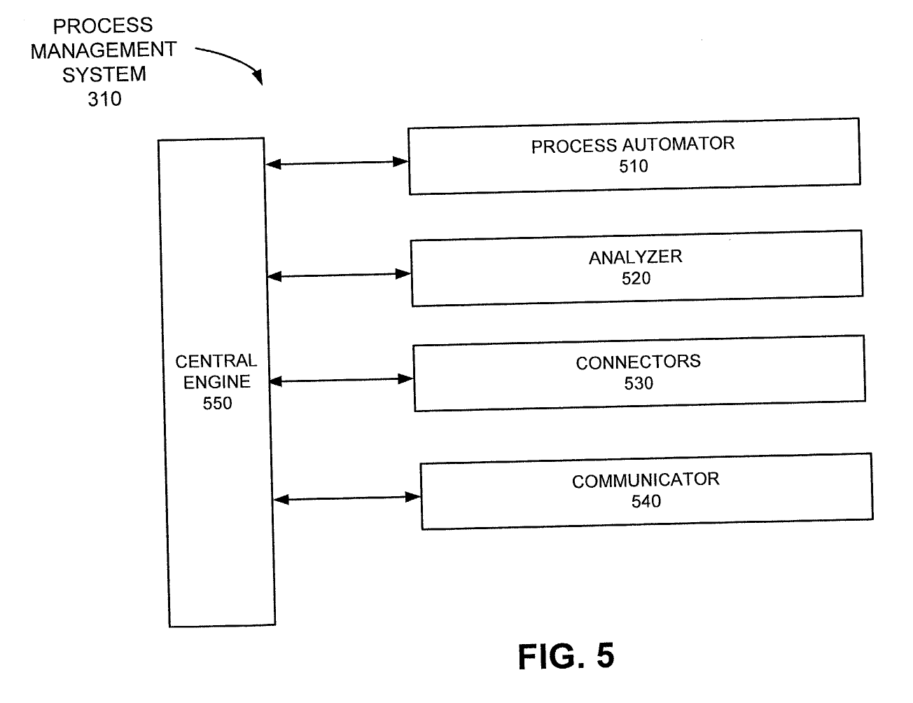

FIG. 5 illustrates an exemplary functional block diagram of the process management system 310 of FIG. 3 in an implementation consistent with the present invention. As illustrated, the process management system 310 includes a process automator 510, an analyzer 520, a group of connectors 530, a communicator 540 and a central engine 550. In an exemplary implementation of the present invention, these elements are implemented as functional modules of a software program executed by processor 420 of the process management system 310. It will be appreciated that the process management system 310 may execute additional functional modules (not shown) that aid in the reception, processing, and/or transmission of data.

The processor automator 510 includes a modeling tool that allows event processing to be visually modeled by engineers and product development analysts. The process automator 510 can then execute these models to create an automated business process executed by the central engine 550. The analyzer 520 provides on-going and real-time monitoring of the components of the OSS 130. The analyzer 520 delivers reports, history, and trending on events processed through the central engine 550. The connectors 530 allow the components of the OSS 130 to interact and communicate with the process management system 310. The OSS components may communicate with the process management system 310 via standard messaging or through full publish/subscribe processing. The communicator 540 enables the process management system 310 to communicate with various components of the OSS 130 using transmission control protocol/Internet protocol (TCP/IP). The central engine 550 is the core of the software program and executes customized rules to enable the process management system 310 to integrate the various systems of the OSS 130, as described in more detail below. It should be understood that the central engine 550 may be programmed to perform any rules-based processing based on the particular requirements associated with managing the OSS 130.

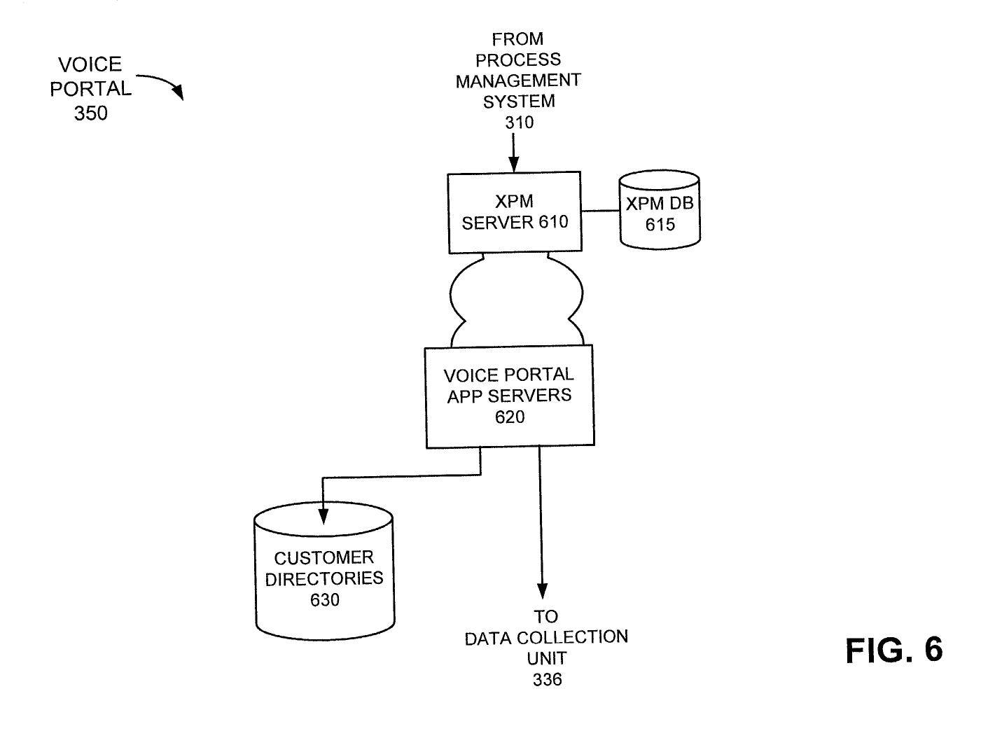

FIG. 6 illustrates an exemplary configuration of the voice portal unit 350 of FIG. 3 in an implementation consistent with the present invention. As illustrated, the voice portal unit 350 includes an extensible profile management (XPM) server 610, an XPM database 615, one or more voice portal application servers 620, and a customer directory database 630. The XPM server 610 receives user profile information from the network interface 320 via the process management system 310 and stores this information in the XPM database 615 for use by the voice portal application servers 620. The XPM server 610 may also receive other information, such as information identifying the device(s) (e.g., personal digital assistant, cellular telephone, pager, computer, SIP device, etc.) by which a user wishes to receive the information associated with a particular service(s) to which the user has subscribed. The XPM server 610 and the XPM database 615 are shown as separate devices. It should be understood that these devices may both be part of the same server in implementations consistent with the present invention.

The voice portal application servers 620 may include one or more servers that interact with the XPM server 610 to provide, for example, banking, brokerage, and financial services, sports, travel, weather and entertainment services, distribution and shipping services, insurance services, health and pharmaceutical services, manufacturing services, and the like. Voice portal application servers 620 may also provide data collection unit 336 with information regarding what services are accessed and by whom. The data collection unit 336 may then pass this information to billing unit 337 for billing purposes. The voice portal application servers 620 may be located at the OSS 130 or distributed throughout the network 110. The customer directories 630 may store information relating to the services provided by the voice portal application servers 620. For example, the customer directories 630 may store stock quotes, current weather forecasts, real-time sports scores, etc. In an exemplary implementation of the present invention, the voice portal application servers 620 communicate with the XPM server 610 and customer directories 630 using extensible markup language (XML).

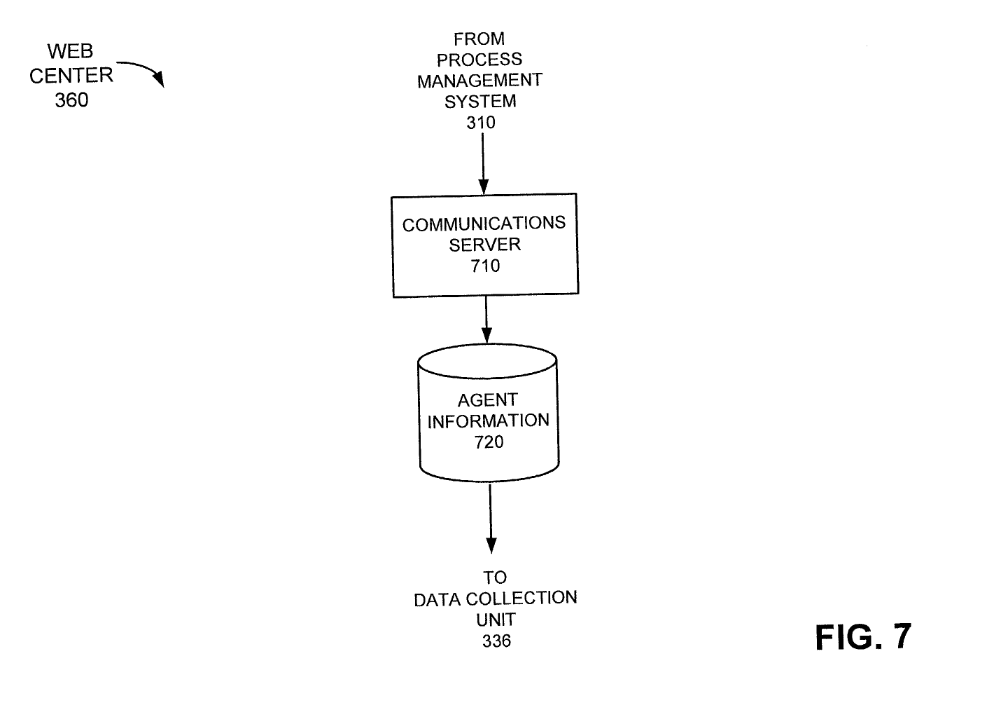

FIG. 7 illustrates an exemplary configuration of the web center 360 of FIG. 3 in an implementation consistent with the present invention. As illustrated, the web center 360 includes a communications server 710 and an agent information database 720. The communications server 710 queues, routes, and distributes communications from any first location to an appropriate agent at any second location. The communications server 710 may determine the appropriate agent based on data stored in the agent information database 720. For example, the agent information database 720 may store information regarding the particular skills of an agent, such as whether the agent speaks a foreign language, such as Spanish. When a call is received from a Spanish-speaking party, the call may be routed to a Spanish-speaking agent.

The agent information database 720 may also store agent activity information. For example, the agent activity information may include the agent's schedule, whether the agent is currently busy, the agent's most recent communication, etc. This activity information may be used to determine the appropriate billing for the customers using the web center 360, as described in more detail below.

Users may also provision new services from web center 360, such as order a toll free number, create new accounts, modify agent information, etc., via the network interface 320. For example, a customer may use network interface 320 to add a new agent, delete an existing agent or modify information associated with an existing agent.

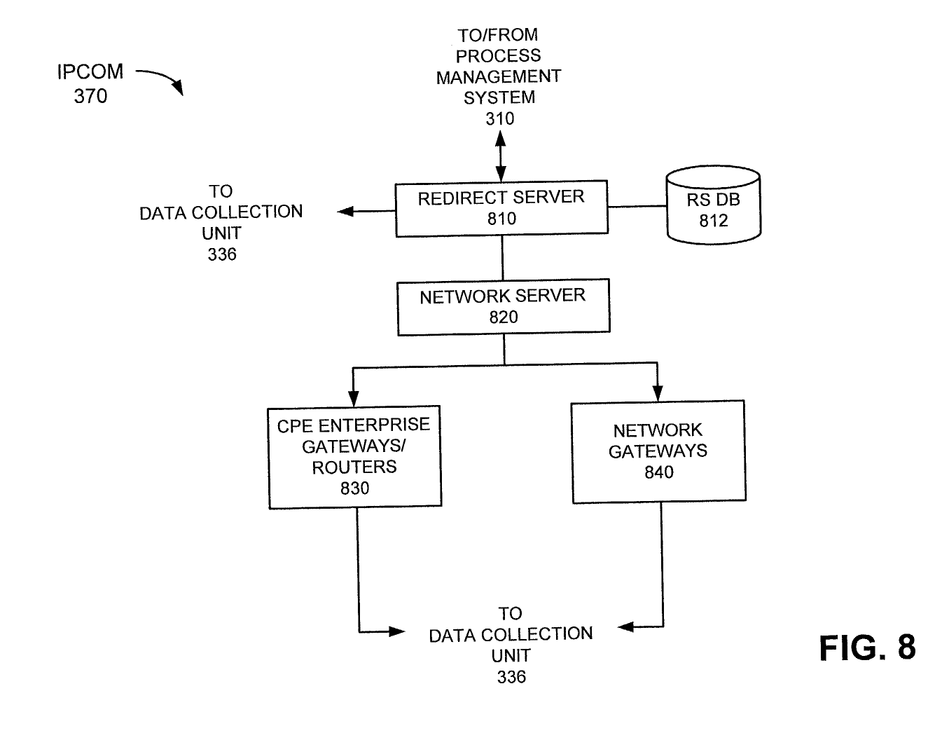

FIG. 8 illustrates an exemplary configuration of the IPCOM unit 370 of FIG. 3 in an implementation consistent with the present invention. As illustrated, the IPCOM unit 370 includes a redirect server 810, a redirect server database 812, network server 820, customer provided equipment (CPE) enterprise gateways/routers 830 and network gateways 840. According to an exemplary implementation, the redirect server 810 executes an object request broker (ORB) that is CORBA compliant. The redirect server 810 stores data in database 812 relating to call processing (e.g., information identifying the device by which the subscriber wishes to receive the call, network configuration information, etc.), subscriber profiles (e.g., a subscriber identifier) and network-supported features. The redirect server 810 may decide how to route calls based on information stored in redirect server database 812. The redirect server 810 and the redirect server database 812 are shown as separate devices. It should be understood that these devices may both be part of the same server in implementations consistent with the present invention.

The redirect server 810 forwards the routing information to the network server 820. The network server 820, also referred to as the proxy server or SIP server, processes the actual calls made over the IP communications network. The network server 820 directs the calls to CPE enterprise gateways/routers 830 or network gateways 840 based on the type of call and the network-supported features to which a customer subscribes. The network-supported features may include, for example, follow me, call blocking, call forwarding, voice mail, conference calling, single line extension, call screening, quality of service, class of service, dial-plan restrictions, dynamic registration, secondary directory number, and call transfer. As described above, a subscriber may change attributes of these network-supported features using the network interface 320. The redirect server 810 may also communicate with the data collection unit 336.

The CPE enterprise gateways/routers 830 may include one or more gateways for linking POTS telephone systems to the IP communications network. The CPE enterprise gateways/routers 830 may, for example, connect to a customer's private branch exchange (PBX) and convert TDM voice data into VoIP packets and voice signaling into SIP messages. The CPE enterprise gateways/routers 830 may also include one or more routers that receive information from a SIP phone over a network, such as a LAN or WAN.

The network gateways 840 may include one or more gateways for linking the IP communications network to the PSTN in a well known manner. The CPE enterprise gateways/routers 830 and network gateways 840 track customer access and transmit this customer access data to the data collection unit 336 for billing purposes.

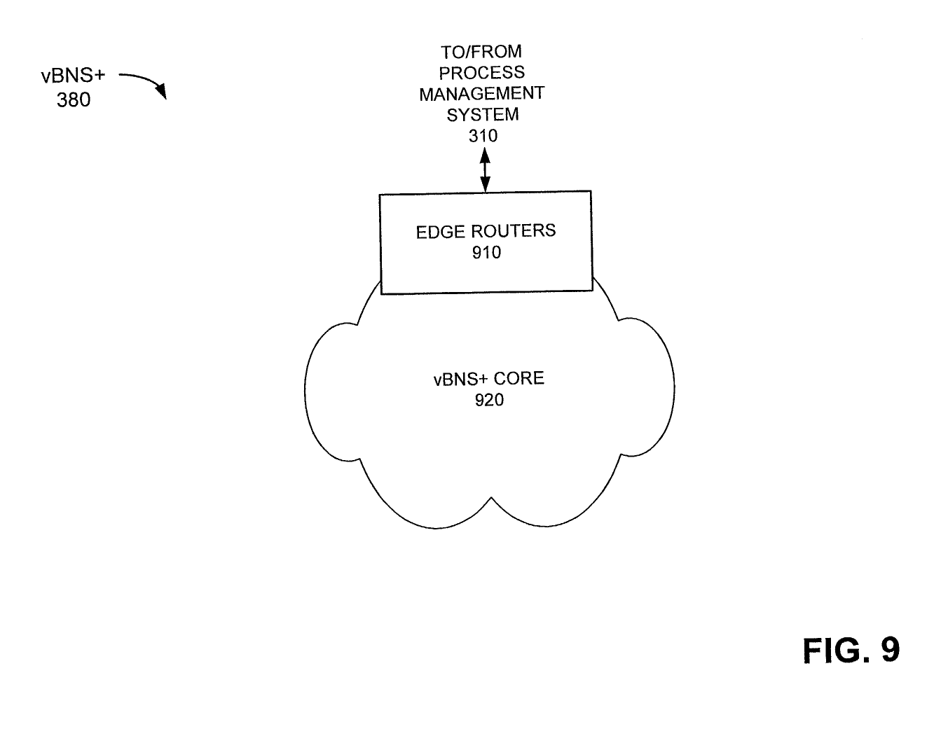

FIG. 9 illustrates an exemplary configuration of the vBNS+ unit 380 of FIG. 3 in an implementation consistent with the present invention. As illustrated, the vBNS+ unit 380 includes a group of edge routers 910 that route packets to/from the vBNS+ core network 920. The edge routers 910 may connect to the network server 820, redirect server 810, network gateways 830, customer's CPE equipment, other routers in the IP communications network, directly to SIP telephones, etc. The vBNS+ core 920 may include one or more core routers for routing packets between edge routers.

The foregoing description of the OSS 130 provides an overview of the components and operations of the OSS 130. A more detailed description of the present invention as embodied, for example, in the OSS 130, is provided below.

### Collecting and Rating Web Center Agent Usage

As described previously, the web center 360 acts as a virtual contact center by routing communications to appropriate agents. The present invention is directed to systems and methods for billing customers for web center 360 services.

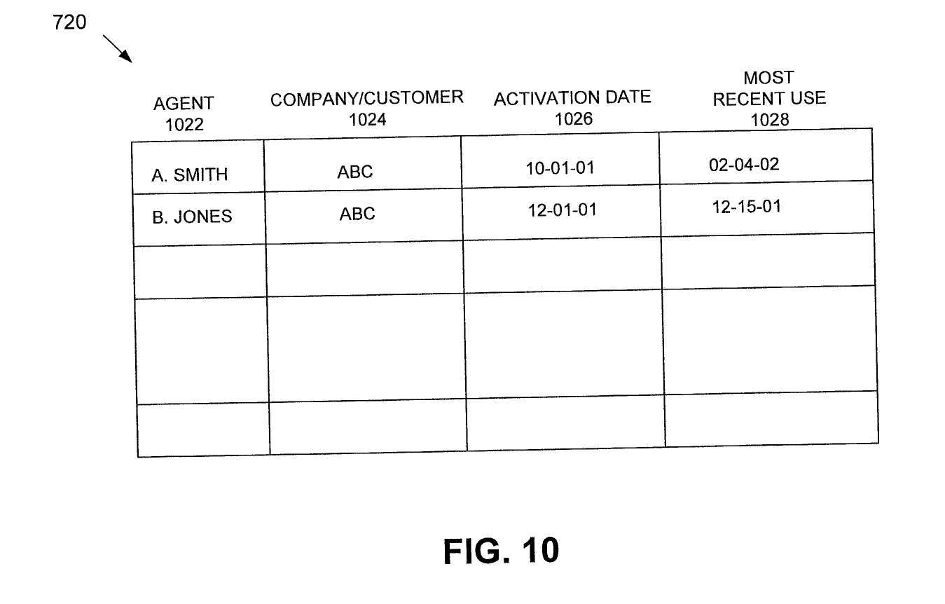

The agent information database 720, as described previously, may store information indicating an agent's skills, the agent's schedule and the agent's activity information. FIG. 10 illustrates an exemplary configuration of the agent information database 720 in an implementation consistent with the present invention. The agent information database 720 includes an agent field 1022, a company/customer field 1024, an activation date field 1026 and a most recent use field 1028. It should be understood that the fields illustrated in FIG. 10 are exemplary and that the agent information database 720 may include other fields, such as fields associated with the agent's skills, schedule, etc. These other fields are not shown in FIG. 10 in order not to obscure the thrust of the present invention.

The agent field 1022 may store a unique indicator for each agent. For example, the unique indicator may be an alphanumeric string. The company/customer field 1024 may store a unique indicator for each respective customer that uses the web center 360. In other implementations of the present invention, the agent field 1022 and company/customer field 1024 may be combined into a single field. In an exemplary implementation consistent with the present invention, each particular company may be associated with one or more toll free numbers, such as 1-800 numbers, one or more e-mail addresses, etc. In this manner, communications server 710 is able to identify an appropriate agent to whom to route a received call, e-mail, etc.

The activation date field 1026 may store information indicating the data on which that particular agent was activated or made available to service calls, e-mails, etc. The most recent use field 1028 may store information indicating the most recent date on which that agent received a call, e-mail, etc. routed via the web center 360. Alternatively, the most recent use field 1028 may store information indicating the most recent date on which the agent logged into the web center 360 platform, i.e., established communications with the communications server 710 to indicate that he/she is ready to receive communications.

The OSS 130 uses the information in the agent information database 720 to determine how many agents were used in a given billing period. The OSS 130 may then use this information in preparing the actual bill for the customer, as described in more detail below.

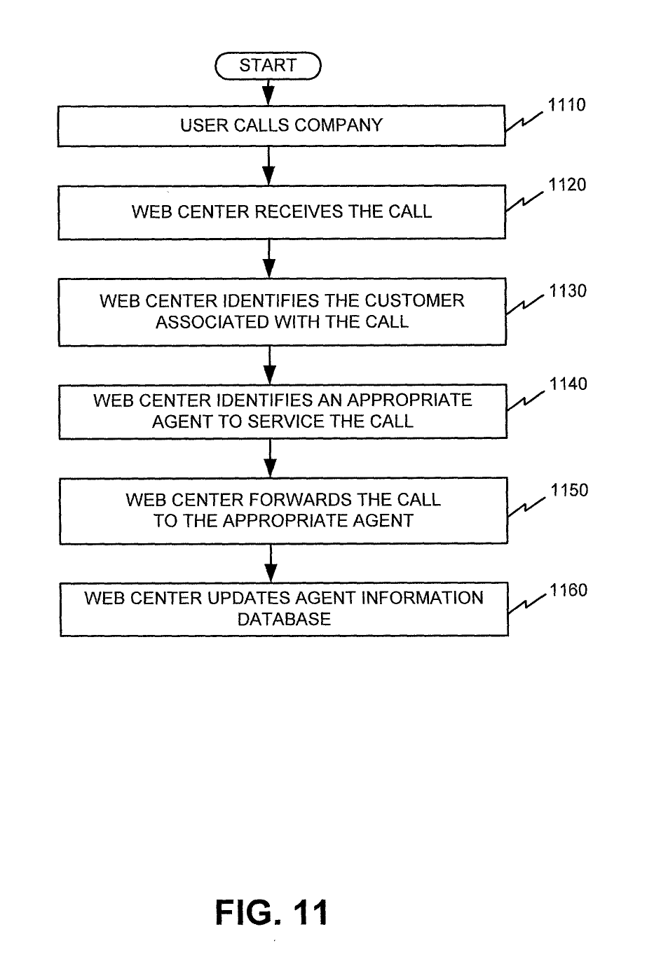

FIG. 11 is a flow diagram, consistent with the present invention, illustrating exemplary processing associated with the web center 360. Processing may begin when a caller calls a company's 1-800 toll free number or a similar number (act 1110). It should also be understood that processing may also being when a user sends an e-mail, facsimile, instant message, etc., associated with a company's contact center. The description below assumes that user makes a 1-800 call. The call may then be forwarded to the web center 360 (act 1120).

The communications server 710 receives the call and identifies the customer associated with the call (act 1130). The communications server 710 may then access the agent information database 720 to identify an appropriate agent to whom to forward the call (act 1140). For example, as discussed previously, the agent information database 720 may include a list of agents associated with each respective customer supported by web center 360. The communications server 710 accesses the agent information database 720 and identifies an available agent to whom to route the call.

After identifying an appropriate agent, the communications server 710 forwards the call to the appropriate agent (act 1150). In an exemplary implementation, the communications server 710 may forward the call to the appropriate system(s) for actually completing the call. For example, in the case of a 1-800 call made via a conventional telephone, the communications server may forward the call via the public switched telephone network (PSTN). If the call is a VoIP type call, the web center 360 may forward the call to IPCOM unit 370, which handles forwarding the call to the agent. Alternatively, if the communication received by the web center 360 is an e-mail sent to the company's e-mail address, the web center 360 may forward the e-mail via an e-mail server included in the web center 360 or via vBNS+ unit 380. Similarly, if the communication is a facsimile or an instant message, the web center 360 may forward the communication via a fax server or a chat server, respectively, that is included in the web center 360. In summary, the web center 360 may forward the received communication in the appropriate manner based on the type of communication.

The communications server 710 may also send an additional communication, such as a web page, an e-mail, an instant message, a facsimile, etc., to the agent's computer that informs the agent of an incoming call and may include information on the caller. For example, if the caller is a previous caller, a web page sent to the agent may include information regarding the caller's previous call(s). This information may assist the agent when servicing the caller.

After the communications server 710 forwards the call to the agent, the communications server 710 updates the most recent use field 1028 in the agent information database 720 to indicate the date on which the call was forwarded (act 1160). This information may then be used for billing purposes, as described in more detail below. In alternative implementations, the most recent use field 1028 associated with an agent may be updated when the agent logs into the web center 360 platform. In other words, when an agent accesses the web center 360 to indicate that he/she is ready to receive communications, the communications server 710 may update the most recent use field 1028 for that agent.

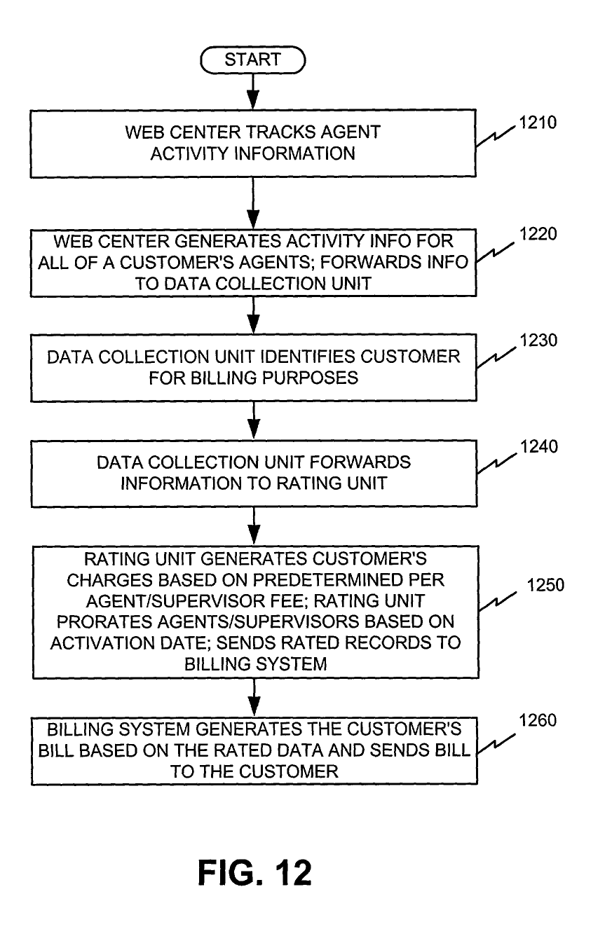

FIG. 12 illustrates exemplary processing associated with billing a customer for usage associated with the web center 360. The communications server 710 tracks the agent information database 720 for agent activity information (act 1210). In an exemplary implementation of the present invention, the communications server 710 monitors the agent information database 720 in real time or near real time to track the agent activity information. For example, the communications server 710 may identify each agent that has received at least one communication (e.g., received a phone call, an e-mail, a facsimile, an instant message, a VoIP call, etc.) in a given billing cycle by monitoring the most recent use field 1028. Alternatively, the communications server 710 may also identify each agent that has logged into the web center 360 in a given billing cycle by monitoring the most recent use field 1028. The communications server 710 may also identify agents that have been recently activated by monitoring the activation date field 1026.

The communications server 710 may continuously monitor the web center 360 in this manner in real time or near real time during the billing cycle. Alternatively, the communications server 710 may periodically monitor the web center 360 to identify the agent activity information. In either case, at the end of a particular customer's billing cycle, the communications server 710 generates information on all of the customer's agents and forwards this information to the data collection unit 336 (act 1220).

The data collection unit 336 receives this information and may execute a program that creates a file associated with the agents of each particular customer. The file may include one record per agent and may indicate whether that agent has received at least one communication forwarded by the web center 360 (e.g., received a call, an e-mail, a facsimile, an instant message, etc.) during that billing cycle. Alternatively, the file may indicate whether the agent has logged into the web center 360 platform during that billing cycle. The record may also indicate whether that agent has been an active agent for the entire billing cycle or for a portion of the billing cycle, based on the activation date field 1026.

The data collection unit 336 may then identify the customer's billing identification for billing purposes (act 1230). For example, the customer identifier 1024 in the agent information database 720 may be different than the customer's identifier in the billing unit 337. In this case, the data collection unit 336 correlates the customer identifier 1024 in the web center 360 to the customer's billing identifier used by the billing unit 337.

The data collection unit 336 may then forward this information to the billing unit 337, also referred to as the rating unit 337 (act 1240). The rating unit 337 may then generate a customer's charges based on the number of agents that were active and received communications during that given billing cycle (act 1250). Alternatively, the rating unit 337 may generate charges based on the number of agents that were active and who logged into the web center 360 platform during the given billing cycle. In an exemplary implementation, the rating unit 337 may also count the number of agents for that customer who received at least one communication or who logged into the web center 360 during that billing cycle and who were active during the entire billing cycle. The rating unit 337 may also include the agents' supervisors in the count if the supervisors were logged into the web center 360 during the billing cycle. The rating unit 337 may charge the customer a fixed amount for each of these agents/supervisors. The rating unit 337 may also charge the customer a prorated portion of the fixed amount for agents/supervisors who received at least one communication or logged into the web center 360 during the billing cycle, but were not active during the entire billing cycle (act 1250). For example, if the agent was active for one half of the billing cycle and received at least one communication or logged into the web center 360, the rating unit 337 may charge the customer one half of the predetermined fixed monthly fee for that particular agent. In this manner, the customer is not charged the full fee when an agent is activated during the billing cycle. In addition, if an agent was active the entire billing cycle, but received no communications or was not logged into the web center 360 during the billing cycle, the billing unit 337 generates no charges for that agent. It should be understood that the particular number of communications that an agent must receive before the customer is charged may be modified in implementations of the present invention.

For example, in alternative implementations, the customer may be billed only for agents that received two communications, or any other number of communications. In addition, in alternative implementations, the customer may be charged two or more different fixed rates based on the number of communications that the agent received. For example, the customer may be charged a first fixed fee for agents who handled between 1 and 100 calls and a second fixed fee for agents who received more than 100 calls. In another implementation, the customer may be charged in a tiered approach. For example, the customer may be charged a first fixed fee for the first X number of agents, a second fixed fee for the next Y number of agents and a third fixed fee for the remaining Z number of agents. In still another implementation, the data collection unit 336 may identify the type of activity performed by the agents. For example, the data collection unit 336 may indicate whether an agent received only telephone calls or instant messages. The rating unit 337 may then charge the customer a different fixed fee for agents that received telephone calls versus agents that received instant messages. In summary, the fixed fee per agent billing model may be modified based on the customer's particular requirements with respect to billing.

After generating the rated records, the rating unit 337 may forward the rated records to a billing system (act 1250). The billing system (not shown) may then create the actual bill and send the bill to the customer (act 1260).

Systems and methods consistent with the present invention provide a billing mechanism based on per-agent fees. One advantage of the invention is that record keeping associated with performing billing is significantly reduced from that required by an event driven billing model. This enables the service provider to save resources and reduces costs associated with billing. Another advantage of the invention is that the billing mechanism allows a customer to activate and de-activate agents based on the customer's particular needs and does not bill the customer for inactive agents. This gives the customer more flexibility with regard to contact center staffing.

In this disclosure, there is shown and described only the preferred embodiments of the invention, but, as aforementioned, it is to be understood that the invention is capable of use in various other combinations and environments and is capable of changes or modifications within the scope of the inventive concept as expressed herein.

For example, the present invention has been described in relation to various units/components of the OSS 130 performing various tasks. In other implementations of the present invention, the tasks described as being performed by one unit/component may be performed by another unit/component. For example, in an alternative implementation of the present invention, the rating unit 337 may be used to perform both rating and billing. Alternatively, the contact center platform, i.e., web center 360, may be used to perform the data collection, rating and billing tasks. In addition, the present invention has been described mainly in relation to a telecommunications service provider providing services associated with a contact center. The present invention may also be used in other systems that include a contact center.

Lastly, aspects of the present invention have been described as series of acts in relation to FIGS. 11-12. It should be understood that the order of these acts may vary in other implementations of the present invention. Moreover, non-dependent acts may be performed in parallel.

No element, act or instruction used in the description of the present application should be construed as critical or essential to the invention unless explicitly described as such. Also, as used herein, the article “a” is intended to include one or more items. Where only one item is intended, the term “one” or similar language is used.

The scope of the invention is defined by the claims and their equivalents.

What is claimed is:

1. A support system, comprising:
a contact center server configured to store agent information for a number customers;
a data collection unit configured to:
monitor the contact center server,
determine a first number of agents associated with a first customer that at least one of logged into the contact center server during a billing cycle and received at least one communication from the contact center server during the billing cycle, and
forward the first number of agents; and
a billing unit configured to:
receive the first number of agents, and
charge the customer a fixed amount for each of the first number of agents.

2. The support system of claim 1, wherein the data collection unit is further configured to:
not charge the customer for a second number of agents that did not log into the contact center server or receive at least one communication during the billing cycle.

3. The support system of claim 1, wherein the data collection unit is further configured to:
identify whether any of the first number of agents were not active during the entire billing cycle, and
prorate the fixed amount for any of the respective first number of agents that were not active during the entire billing cycle.

4. The support system of claim 1, wherein the at least one communication comprises any one of a phone call, an e-mail, an instant message, a facsimile and a voice over Internet protocol (VoIP) communication.

5. The support system of claim 1, wherein when monitoring the contact center server, the data collection unit is configured to monitor the contact center server in real time.

6. A method for billing a customer for services associated with a contact center, the method comprising:
determining a number of agents associated with the customer during a billing cycle; and
charging the customer a fixed amount for each agent.

7. The method of claim 6, wherein the determining a number of agents includes at least one of identifying each agent that received at least a predetermined number of communications during the billing cycle and identifying each agent that logged into the contact center during the billing cycle.

8. The method of claim 7, wherein the charging includes:
charging the customer a fixed amount for each agent that received at least the predetermined number of communications during the billing cycle or logged into the contact center during the billing cycle, and
not charging the customer for each agent that did not receive at least the predetermined number of communications during the billing cycle or did not log into the contact center during the billing cycle.

9. The method of claim 8, wherein the predetermined number is one and the communications include telephone calls, e-mails, instant messages, facsimiles and voice over Internet protocol communications.

10. The method of claim 7, wherein the communications include telephone calls, e-mails, instant messages, facsimiles and voice over Internet protocol communications and the charging includes:
charging the customer a fixed fee per agent based on the type of communications that each respective agent receives.

11. The method of claim 6, wherein the determining includes:
identifying a first number of agents that received at least one communication during the billing cycle and were active during the entire billing cycle, and
identifying a second number of agents that received at least one communication during the billing cycle and were not active during the entire billing cycle.

12. The method of claim 11, wherein the charging includes:
charging the customer a fixed amount for each of the first number of agents, and
charging the customer a prorated portion of the fixed amount for each of the second number of agents.

13 The method of claim 12, wherein the charging the customer a prorated portion of the fixed amount for each of the second number of agents includes:
charging the customer based on the portion of the billing cycle in which each of the respective second number of agents was active.

14. The method of claim 6, further comprising:
storing, in a database, an indicator for each of a plurality of agents associated with the customer, the indicator indicating at least one of whether the corresponding agent has received at least one of a phone call, an e-mail, an instant message, a facsimile or a voice over Internet protocol (VoIP) call and whether the corresponding agent logged into the contact center.

15. The method of claim 14, wherein the charging includes:
accessing the database to identify agents based on the stored indicators, and
charging the customer for each agent whose corresponding indicator indicates that the agent has received at least one of a phone call, an e-mail, an instant message, a facsimile, or a VoIP call or that indicates that the agent logged into the contact center.

16. A computer-readable medium having stored thereon a plurality of sequences of instructions, said sequences of instructions including instructions which, when executed by a processor, cause the processor to:
monitor a contact center server for agent activity information, the server storing information for a plurality of agents associated with a customer;
determine a first number of agents that received at least one communication during a billing cycle or logged into the contact center server during the billing cycle; and
charge the customer a fixed amount for each of the first number of agents.

17. The computer-readable medium of claim 16, including instructions for causing the processor to:
not charge the customer for a second number of agents that did not receive at least one communication during the billing cycle or who did not log into the contact center server during the billing cycle.

18. The computer-readable medium of claim 17, including instructions for causing the processor to:
identify whether any of the first number of agents were not active during the entire billing cycle; and
prorate the fixed amount for any of the first number of agents who were not active during the entire billing cycle.

19. The computer-readable medium of claim 16, wherein the at least one communication comprises any one of a phone call, an e-mail, an instant message, a facsimile and a voice over Internet protocol (VoIP) communication.

20. The computer-readable medium of claim 16, wherein when monitoring the contact center server, the instructions cause the processor to monitor the contact center server in real time.

21. A contact center platform, comprising:
a database configured to store information on a plurality of agents associated with a customer; and
a server configured to:
receive communications intended for the customer,
access the database to identify an agent associated with the customer,
forward the communication to the identified agent,
determine a first number of the plurality of agents that received at least a predetermined number of communications during a billing cycle, and
generate billing information based on a fixed amount for each of the first number of agents.

22. The contact center platform of claim 21, wherein the predetermined number is one.

23. The contact center platform of claim 22, wherein the server is further configured to not charge the customer for a second number of agents that did not receive at least one communication during the billing cycle.

24. The contact center platform of claim 23, wherein the server is further configured to:
identify whether any of the first number of agents were not active during the entire billing cycle, and
prorate the fixed amount for any of the first number of agents that were not active during the entire billing cycle.

25. The contact center platform of claim 21, wherein the communications include telephone calls, e-mails, instant messages, facsimiles and voice over Internet protocol communications.
